(19) United States
(12) Patent Application Publication
(10) Pub. No.: US 2015/0339845 A1
(43) Pub. Date: Nov. 26, 2015

(54) DISPLAY MAT

(71) Applicants: Jörg PRIVSEK, Krefeld (DE); Günther SCHNELLHARDT, Poing (DE)

(72) Inventors: Jörg PRIVSEK, Krefeld (DE); Günther SCHNELLHARDT, Poing (DE)

(21) Appl. No.: 14/442,773

(22) PCT Filed: Jun. 14, 2013
(86) PCT No.: PCT/EP2013/062438

§ 371 Date: May 14, 2015

(30) Foreign Application Priority Data
Nov. 14, 2012 (DE) 20 2012 010 931.6

(51) Int. Cl. G06T 15/20

(52) U.S. Cl. CPC G06T 15/20

(57) ABSTRACT

A mat may have a display surface for displaying information such that from the viewing point of a camera, the viewing angle of which extends at an angle that is oblique to the display surface, the mat appears to stand three-dimensionally upright. The mat may be further developed by means of LEDs, which, distributed across the display surface, are integrated into the mat, by way of which the information can be displayed, and by means of an electronic control unit, by way of which the LEDs can be switched and/or controlled, either individually, in groups, and/or in any desired patterns. A method may include transmitting data, which are reproduced by at least one such mat located on a floor. A system for transmitting data may use at least one such mat.

The invention relates to a mat having a display surface for displaying information such that from the viewing point of a camera, the viewing angle of which extends at an angle that is oblique to the display surface, the information appears to stand three-dimensionally upright. The invention further relates to a method for transmitting information, which is reproduced by at least one mat located on a floor. Lastly, the invention further relates to a system for transmitting information by way of at least one mat.

It is an established practice to provide hoardings at sports grounds with data or advertising. In football and other sports it is, however, not always possible to install hoardings close to the side of the pitch. For example, no hoardings may be installed in the area behind the by-line for the footballers' protection. This very area is, however, particularly sought after for advertising purposes especially, since the pitch-side areas adjacent to the goals appear in the viewers' field of vision more often than the areas close to the sidelines. This applies to a greater extent to film camera recordings of football games, when the viewers' field of vision is limited by the image captured by the film camera.

One solution to this problem is to place advertising on the ground while presenting the advert in such a way that, when viewed from a certain point, it seems to be protruding from the ground, and thus standing upright. In order to achieve this, a distorted version of the image to be perceived is projected onto the floor so that a three dimensional effect is produced for the viewer owing to an optical illusion. As a rule, the distortion takes place in order to project onto the floor the image of an advertising surface that appears, from the viewer's position, to be standing upright, by means of the intercept theorem. DE 92 19 218 U1 discloses a method whereby an image that is to be perceived as standing undergoes an inverse perspective transformation such that a representation of the inverse perspective image on the floor is perceived by a viewer as upright.

DE 198 37 887 A1 discloses a process wherein an advert, which is portrayed in an inverse perspective in the horizontal plane, is placed on a so-called floor layer, in other words on a mat lying on the floor, so that the advert can be easily removed or positioned elsewhere. The document suggests a manual method involving the use of measuring sticks to produce an appropriate inverse perspective display on the mat. These printed or painted floor layers are known in the market as ‘cam carpets’. To date, they have been used primarily for advertising in football stadiums.

International patent application WO 00/63868 A1 discloses a method whereby the image to be recorded by a film camera undergoes an inverse perspective transformation, wherein the inverse perspective projection is carried out by means of a floodlight located at the position of the film camera which is to record the image.

WO 2005/104535 A1 discloses an advertising surface the display surface of which is set at an acute angle to the horizontal plane and the aim of which is to support an inverse perspective distorted image. This is intended to enable the advertising surface to be used on the ground in pitch-side areas, given that it is largely horizontal, while the space required for the advertising surface is reduced, since, by setting the advertising surface at an acute angle, the surface required for the inverse perspective representation of the image is smaller.

A disadvantage shared by all previously known methods is that the distorted representation on the ground can only be perceived optimally, as a so-called ‘stand up’ image, from a particular film camera position; the advert captured by a film camera in another position is hardly noticed, since the advert can only be viewed as a distorted image from that viewpoint and is unlikely to attract the viewer's attention.

The underlying purpose of the invention is to provide a mat of the kind stated at the beginning, wherein this disadvantage does not exist or is at least considerably improved upon.

This purpose is achieved by means of a mat having the features of claim 1.

According to the above claim, the invention consists of a mat of the kind stated at the outset, characterised by LEDs which are spread across the display surface and built into the mat and enable information to be displayed, and by an electronic control unit by means of which the LEDs can be activated individually, in groups and/or according to any pattern.

Here and in the following, the term ‘information’ is understood to mean pictures or film sequences of any kind, particularly those featuring letters, text, symbols or logos.

LEDs are light-emitting diodes. They may be monochromatic, whereby preferably three LEDs emitting the primary colours red, blue and green can be interconnected to a group of LEDs to portray a pixel. It is, however, preferable to use multi-colour LEDs (e.g. RGB LEDs) to represent a pixel. Depending on their size, any number of LEDs can be incorporated or integrated into the mat according to the invention. The more LEDs used per unit of surface area, the greater the resolution of the mat.

The electronic control unit serves to control all of the LEDs built into the mat. Since it is possible to control each LED individually, any kind of picture information can be displayed by switching on the appropriate LEDs. Furthermore, depending on the position of the camera, the perspective distortion of the information to be displayed can be adjusted according to the viewing angle by activating the appropriate LEDs. The control unit can also be configured such that the LEDs are supplied with electricity.

As a result, it is possible to alter the information that can be displayed by means of the mat, meaning that the information can be optimally displayed not only for one particular viewing point (the position of a film camera), but also for a number of viewing points over time as needed. If a number of film cameras are involved in the transmission of a fixture such as a football match or another sporting event, the information to be displayed can be distorted such that, from the viewing point of the leading camera in use at the time, in other the words the film camera broadcasting its image to the viewers, it is perceived as three dimensional (protruding out of the plane of the display surface) and standing upright. Accordingly, when using one or more mobile cameras, it is also possible to adjust the distortion of the information to the current position of the film camera at any given time, even continuously if required. In addition, information, such as images, image or video sequences or similar, can be presented with a different perspective distortion simultaneously. This means that pieces of information simultaneously displayed on a single display surface, whether they are the same or different, can be perceived as upright information by different cameras at the same time.

Thus, as an advertising medium and information tool, the mat according to the invention is not only suited to football pitches, but also to a range of other sports grounds and events.

The electronic control unit can be connected to a computer system (not pictured here) via a data interface, and consequently it can be supplied with the necessary data for displaying a piece of information on the display surface. Depending on the configuration of the electronic control unit, it can, in one embodiment, contain (only) one system for controlling the individual LEDs, wherein it then receives the data of the image to be portrayed, already distorted in accordance with the position of the recording camera, from a further computer system via a data interface (e.g. cables or a wireless interface). In a further embodiment of the electronic control unit, it can be provided with a data interface which transmits the information concerning the position of the transmitting camera and the image data of the image to be transmitted by the camera, together with a computing capacity, to the control unit such that it automatically transforms the image into a distorted image, allowing for the camera's position in relation to the display surface.

It is, of course, also sufficient if the image or images to be distorted are stored in a memory in the electronic control unit and the image to be displayed at a particular time is selected from the memory using an external signal or a corresponding controller and displayed on the display surface in a distorted form. If several cameras are used at fixed positions, it could be useful for the images, distorted according to the different camera positions, to be stored as image data in a memory in advance and for the electronic control unit to select the distorted image corresponding to the position of the then active camera from the memory or receive it via a data interface and display it. If only one camera is used in a fixed position, or if the chronological order of the different positions of one or more cameras is known in advance, it would even be possible to dispense with the data interface responsible for transmitting a signal that indicates which camera is active or where it is located, and the chronological order of the information to be displayed by means of the display surface could be stored in a memory of the electronic control unit.

By using pre-programmed patterns or stored distorted images, the display can be changed as often as desired and as quickly as possible using the control box. Therefore, the mat according to the invention considerably enhances advertising potential.

Preferably, the mat according to the invention features a casing with at least one upper segment forming the display surface and at least one base segment, wherein cavities for accommodating LEDs or circuit boards bearing the LEDs are embedded in the upper segment and/or in the base segment. This allows the LEDs or the circuit boards with the LEDs to be easily positioned inside the casing and to be held securely in the cavities once the casing has been closed. In addition, it is possible to replace faulty LEDs, faulty leads connecting the LEDs to the electronic control unit or other faulty components provided the upper side and underside of the casing can be opened again.

Preferably, the casing is configured as waterproof and consequently the mat can be used outdoors as well as inside buildings or covered stadiums, since the current-carrying parts of the mat have a waterproof covering. As an alternative or in addition to a waterproof casing, the current-carrying components themselves can have a waterproof covering. For example, if circuit boards are used as supports for the LEDs, these could have a waterproof coating just as the components for connecting the circuit boards to the control unit and the electrical components of the control unit itself can be provided with a waterproof coating.

It is also advantageous if the mat according to the invention is step-resistant, and consequently is not damaged when it is used on the ground.

In a preferred embodiment of the invention, the display surface is comprised of a surface that is substantially non-transparent, more particularly black, with a matrix of transparent or translucent segments embedded in it, wherein one LED or a group of LEDS is assigned to each transparent or translucent segment. The transparent or translucent segments form clearly defined pixels, wherein a black, non-transparent surface gives the information on display a high-contrast appearance.

In a preferred embodiment of the invention, at least the upper segment of the casing, and preferably all casing segments, are substantially composed of rubber or a rubber-elastic material, on the one hand, enabling the mat to adapt to uneven terrain, and on the other, significantly reducing risk of injury should a person fall on the mat. Moreover, rubber is particularly slip-resistant, meaning that if the underside of the casing is composed substantially of rubber, the mat is well protected against slipping and, if the upper segment of the casing has a surface made of rubber, a person cannot slip on it.

In particular, if the entire casing of the mat according to the invention is rubber elastic, it can be useful to connect adjacent circuit boards on which the LEDs are arranged to one another by means of an articulated and/or flexible connection. This preserves the flexibility of the mat according to the invention, allowing it to be folded up or even rolled up. This means that the mat, particularly the section containing its display surface, is flexible as well as smooth and safe to walk on. Even if only the upper segment of the casing is rubber elastic, an articulated or flexible connection between the circuit boards can be useful.

In a particular embodiment of the mat according to the invention, the LEDs should be incorporated into the mat such that if direct contact occurs, for example if the mat is stepped on or somebody falls on it, firstly, these are not damaged, and secondly, they do not cause injury. To this end, if the upper segment of the casing is rubber elastic, it may, for instance, be useful to cover the circuit boards with step-resistant cover panels made, for example, of a plastic which is transparent or translucent at least in sections, so that the LEDs and the circuit boards are protected against impact from above. For this purpose, the casing can be configured such that the step-resistant cover is supported on the base segment of the casing, and consequently impact from above bypass the circuit board and are discharged into the base segment.

In a further preferred configuration of the step-resistant cover, it has transparent or translucent projections which are embedded as transparent or translucent segments of the display surface in recesses in the display surface provided for this purpose.

In another further development of the invention, the step-resistant covers are arranged such that they largely overlap the impact edges of adjacent LED circuit boards so as to protect the edges.

Since the mats according to the invention are mainly used at major events, it is useful or even required, depending on the event, for them to be made of flame-resistant material.

In a further preferred embodiment, the mat according to the invention can be configured such that it can only process encoded image data with a view to preventing the mat from being used without permission. To this end, the mat's control unit can include software and/or a driver circuit for decoding image data sent to the control unit in encrypted format. As an alternative or in addition to the above, decoder units, arranged downstream from the control unit and upstream from one or a plurality of LEDs, can also be provided for decoding the image data. In the case of image data that are encrypted in two layers, it is possible to firstly decode the first encryption layer in the control unit using appropriate software and/or hardware and then transfer the image data still encrypted in the second layer to the LEDs, wherein the data to be fed to the individual LEDs are fully decoded by means of driver circuits which, for example, are arranged on the circuit boards on which the LEDs sit. The first layer of encryption and decoding can, for example, relate to the section of image data intended to assign colour and/or brightness information to a pixel. The second layer of encryption can then, for example, relate to the colour and/or brightness information of each pixel. Consequently, following the decoding of the image data contained in the first layer, the control unit would be able to transfer the pixel information to the particular LED for which the pixel information is intended. The pixel information still decoded in the second layer is then decoded for the respective LED by a driver unit (or another piece of software), for instance.

In a further preferred configuration, the mat according to the invention features connection means, particularly on at least one of its flat sides, for connecting a further mat module with a display surface fitted with LEDs and/or for connecting a further electronic control unit. As a result, the display surface can, in principle, be extended as required by attaching additional mat modules.

The purpose of the invention is also achieved by a method for transmitting information, which is displayed by at least of one of the mats according to the invention lying on the ground, which involves at least one film camera, the position of which can be altered during transmission, and/or two or more film cameras, and is characterised in that the electronic control unit distorts the display of information according to the position of the film camera which is intended to transmit the information, as a result of which the information can be perceived as largely three dimensionally upright when viewed from the position of the film camera. It is also advantageous if, in this process, the information to be displayed by the mat is selected according to the film camera position from a number of pieces of information available for display (images and film sequences). It is then possible, for instance, to only display an advert for a first product for a first camera, and to only display an advert for a second product for a second camera using the same mat according to the invention.

In principle, the methods for inverse perspective projection based on the intercept theorem already known from the prior art can be used to adapt the information to be displayed to the camera position or to the viewing angle. Suitable methods are also described in the prior art documents cited at the outset. These methods for achieving the inverse perspective projection of a three-dimensionally upright image on a floor area are, however, relatively complex. In the case of simple graphic displays, a simplified distortion of the information to be displayed can involve moving all pixels in a vertical column of pixels row by row by the same distance, so that the pixels in a pixel line that were previously arranged vertically to one another now stand at an equal angle to one another. This angle increases as the viewing angle of the camera projected into the plane of the display surface increases in relation to the surface normal of the display surface. Moreover, during the distortion process, the vertical distance between adjacent pixels can be uniformly altered across the height of the image. As the camera's viewing angle to the horizontal plane becomes shallower, the vertical distance between individual pixels increases. As a result, the depiction of a rectangle with horizontal top and bottom edges is transformed into a parallelogram with horizontal top and bottom edges. This simplified method is particularly suitable, therefore, if there is a considerable distance between the viewer or camera and the display surface, for example a distance of more than 20 metres or more than 50 metres.

Particularly when adjusting the distortion to the position of a moving camera or when changing the active camera (leading camera) during transmission, it is particularly advantageous if the distortion of the information to be shown, as required for the display, is determined in real time according to the position of the film camera.

The mat according to the invention is also suitable for displaying two or more pieces of information at the same time for different cameras, such that at least one first piece of information is perceived by one of the cameras as three dimensionally upright and at least a second piece of information is perceived by a different camera as three dimensionally upright. To this end, the display of the first information is distorted according to the position of the film camera intended to transmit said first information as substantially three dimensionally upright, and the display of the other information is distorted according to the position of the other film camera intended to transmit said second information as substantially three dimensionally upright. In this regard, it can be particularly advantageous if the two or more pieces of information are displayed alternately one after the other, wherein one piece of information is displayed for a length of time less than or equal to the shutter speed of a first camera and is synchronised with said camera, and the other piece of information is displayed for a length of time less than or equal to the shutter speed of a second camera and is synchronised with said camera, and wherein the cameras are synchronised such that the respective shutter speeds follow one after the other in turns and do not coincide. In effect, this means that the first camera only records one piece of information and the second camera the other.

As an alternative or in addition thereto, the mat according to the invention is, naturally, also suitable for displaying two or more pieces of information at the same time in such a way that, when viewed from the position of a film camera, it appears as though they are standing three dimensionally upright one behind the other. To this end, the different pieces of information are distorted accordingly depending on the camera's position in relation to the position in which it is intended to be perceived by the viewer. If the viewer's position moves, owing to a movement by the film camera, for example, this would result in the image to be perceived as anterior information being distorted differently from the image to be perceived as posterior information (if the camera moves in a purely transverse direction while the distance to the display surface remains substantially constant, the image to be perceived as anterior information undergoes a faster and therefore stronger distortion compared to the image to be perceived as anterior information). Here, too, it can be useful for the two or more pieces of information which are intended to be perceived as standing three dimensionally upright one behind the other to be displayed in sequence one after the other, and to adjust the display times for the individual pieces of information to the shutter speed of the camera that is intended to record them.

In principle, it can be useful, particularly when using information comprising several components, to avoid displaying these components simultaneously, and rather to display different components of the information as partial images in such quick succession that they are still perceived as simultaneous by the human eye, and to adjust the display times of the partial images to the shutter speed(s) of the camera(s) and synchronise them accordingly.

The purpose of the invention is also achieved by means of a system for transmitting image data using at least one film camera the position of which can be altered during transmission and/or using two or more film cameras, together with at least one mat according to the invention. To this end, it is useful and necessary for the system to include means that allow a signal to be transmitted to the electronic control unit, on the basis of which the electronic control unit learns which film camera is active as regards the transmission of the information and/or the position of the film camera which is active as regards the transmission of the information.

Compared to the known cam carpet described at the outset, this system offers an additional significant advantage in that the coloured display of the information can be calibrated automatically by means of a visual comparison with the film camera according to adjustable colour values or manually using software.

In an advantageous configuration of the system, the display refresh rate of the mat can be calibrated with the film camera(s). This prevents the information from being transmitted as a flickering image on the display panel.

In the following, the invention is explained in more detail with the aid of figures showing the basic design of a preferred embodiment of the mat according to the invention.

They show

FIG. 1 a top view of an embodiment of the mat according to the invention;

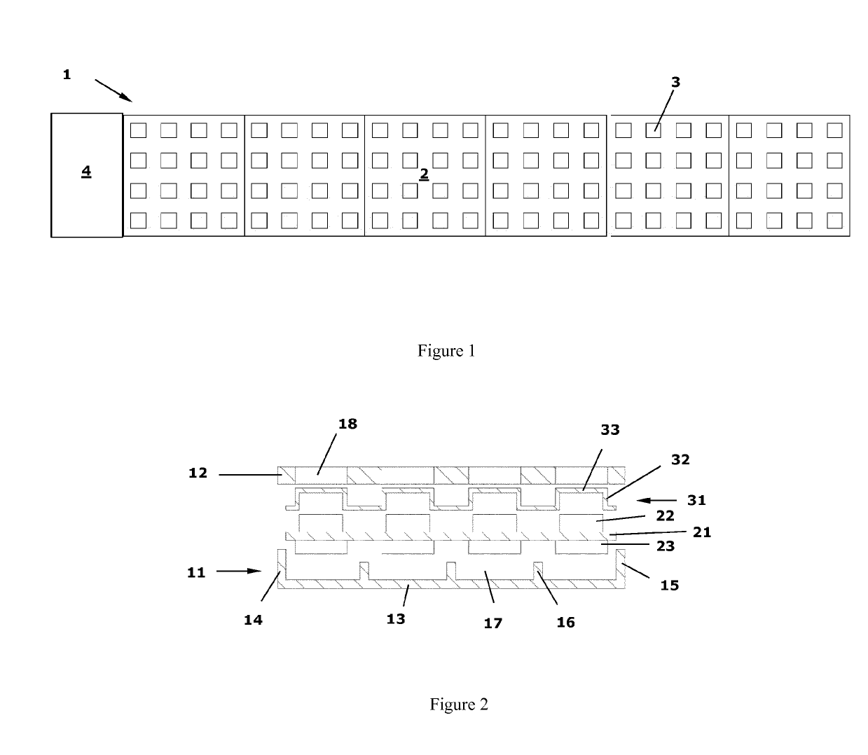

FIG. 2 a cross section of the intrinsic components of an embodiment of a mat according to the invention;

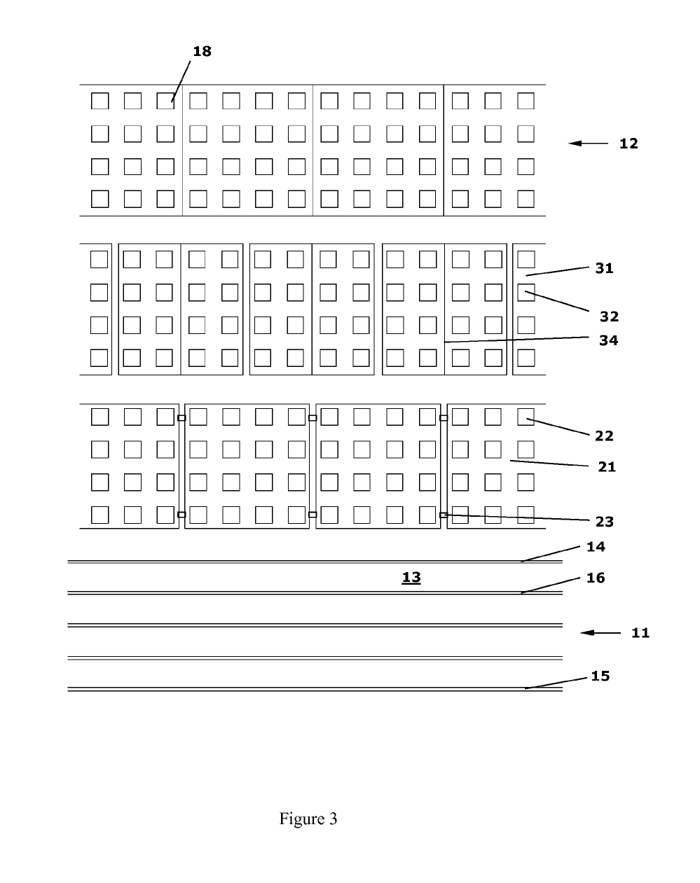

FIG. 3 a top view of the components of the embodiment shown in FIG. 2;

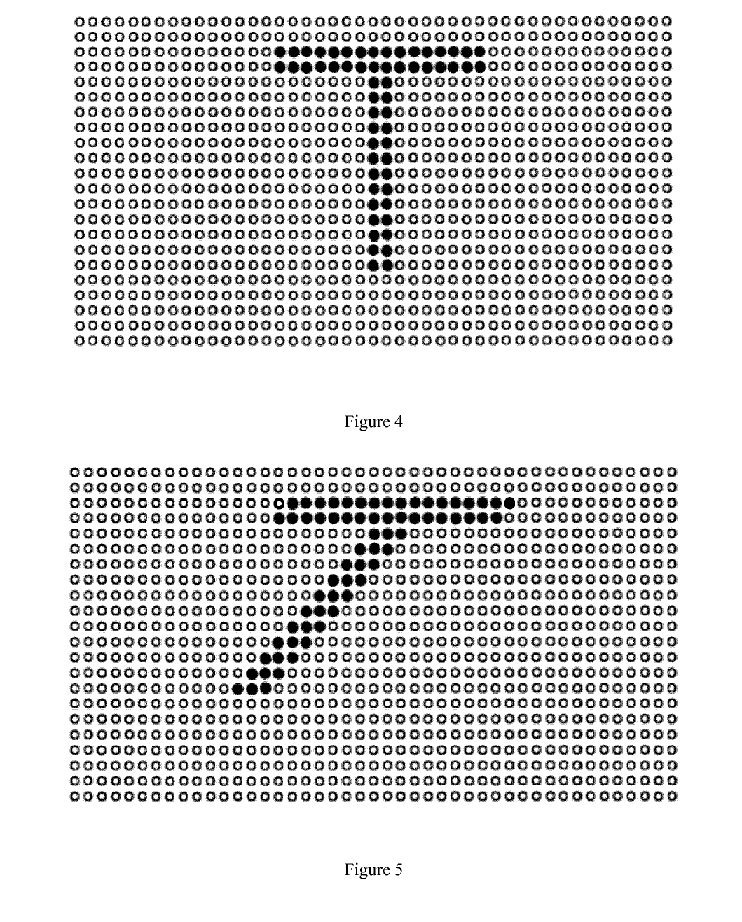

FIG. 4 an example of a pixel matrix with a letter that appears undistorted;

FIG. 5 the pixel matrix example with a letter that appears distorted; and

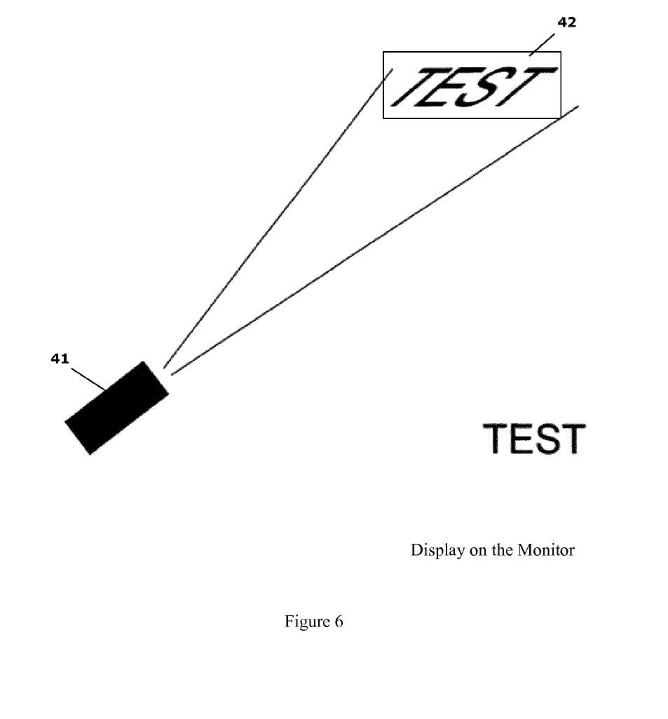

FIG. 6 a basic depiction of the camera recording, as well as the image recorded by the camera and the image displayed via a monitor.

The top view of an embodiment of the mat 1 according to the invention shown in FIG. 1 depicts an oblong display surface 2 with a plurality of pixels 3 arranged in a matrix. An electronic control unit 4, which activates and controls the pixels for displaying a piece of information, is provided on a short side of the display surface.

FIGS. 2 and 3 show the structure of the mat 1 in the region comprising the display surface 2. It features a casing formed by a base segment 11 and an upper segment 12. The casing surrounds a plurality of circuit boards 21, each equipped with 16 multi-coloured LEDs 22 arranged together in a square matrix, and connected to each other in the longitudinal direction of the mat via flexible tracks and to the electronic control unit 4, as well as step-resistant cover panels 31 to protect the circuit boards 21 and the LEDs 22 arranged thereupon.

The base segment 11 of the mat 1 is made of rubber or rubber-elastic material and features a level base 13 and walls 14, 15 arranged at its sides running in the longitudinal direction of the base segment 11. One or more (three in the embodiment shown) divider bars 16 running parallel to the side walls 14, 15 can be provided on the upper side of the base 13, dividing the space defined by the base 13 and the walls 14, 15 into individual chambers 17 extending in the longitudinal direction of the mat.

The clear width between the walls 14, 15 corresponds to the width of the circuit boards 21. The circuit boards 21 sit in the base segment 11, the flexible tracks 23 run between the divider bars 16 in the chambers 17 (cavities), and the circuit boards 21 are supported on the divider bars 16. In the embodiment of the invention, the circuit boards 21 are placed in the base segment 11 such that the distance between all of the adjacent LEDs 22 in the longitudinal direction is essentially the same and corresponds to the matrix of the pixels 3 shown in FIG. 1.

The width of the cover panels 31 for protecting the circuit boards 21 and the LEDs 22 corresponds to the width of the circuit boards 21 and consequently the cover panels 31 lie flat on the inner surfaces of the walls 22, 23 along with the circuit boards 21. The cover panels 31 have a matrix-like form with elevated segments 32 which each surround an LED 22 like a lid. The cover panels 31 are made of a transparent or translucent material at least in the upper sides 33 of the elevated segments 32, allowing the light from the LEDs 22 to shine through. In the present embodiment, the upper sides 33 of the elevated segments 32 have a square cross section, although this can also be circular or have a different shape. The matrix-like arrangement of the elevated segments 32 corresponds to the matrix-like arrangement of the LEDs 22 on the circuit boards 21.

The breadth and length of the cover panels 31 are equivalent to the respective measurements of the circuit boards 21. However, as suggested in FIG. 3, a cover panel 31 is not put on just one circuit board 21, but is positioned in such a way that the cover panel 31 covers adjacent circuit boards 21 in equal shares. In order that the mat 1 does not lose its flexibility as a result of this, the cover panels 31 are each provided with a slot 34 in the centre running at right angles to the longitudinal direction of the mat, making them flexible in the region of the impact edges of adjacent circuit boards 21.

The height of the divider bars 16 of the base segment 11 is selected in proportion to the height of its walls 14, 15 such that the lateral upper edges of the cover panels 31 positioned on the circuit boards 3 are flush with the upper sides of the walls 14, 15.

The upper segment 12 of the casing, which is preferably made of rubber or a rubber-elastic material, just like the base segment 11, features recesses 18, the cross section of which corresponds to the cross section of the elevated segments 32. The upper segment 12 of the casing is positioned on the cover panels 31, or the cover panels 31 are fitted on the inside of the upper segment 12 of the casing, in such a way that the elevated segments 32 of the cover panels 31 sit in the recesses 18 and their upper side 33 is flush with the upper side of the upper segment 12 of the casing. At the same time, the elevated segments 32 should preferably act as a waterproof seal for the recesses 18 or a watertight sealing (for example, silicone seal) should be provided to prevent water from entering the mat. The upper segment 12 of the casing has a watertight bond or seal with the walls 14, 15 of the base segment 11.

For safety reasons, it can be useful if the mat is configured for operation with a voltage of 24 V or less.

In FIG. 1, an electronic control unit 4 is arranged on one of the sides of the mat. In order to achieve redundancy of the electronic control unit, it is possible to provide two electronic control units, one on each side of the mat, both of which are in contact with the tracks 22 so that, should a malfunction occur in one of the electronic control units, the LEDs can be controlled or operated by the other electronic control unit.

By way of example, FIG. 4 shows an LED matrix on which a letter T is represented as it is intended to be captured, standing upright, by a camera. In order to achieve this with a substantially horizontal display surface and a camera the viewing angle of which is oblique to the surface normal of the display surface, the image undergoes an inverse perspective distortion in which the pixels representing the T belonging to a horizontal pixel row are shifted row by row with respect to the adjacent horizontal pixel row by substantially the same distance so that the pixels that were previously arranged vertically to one another now stand at an approximately equal angle to one another. A distortion of this kind takes place according to the viewing angle of a camera on the advertising space to be perceived. FIG. 5 depicts a letter T distorted in this way.

FIG. 6 contains a drawing of the positioning of a camera 41, the viewing angle of which runs obliquely, both vertically and horizontally (not shown here), to the surface normal of a mat 42 according to the invention. The image displayed on the display surface (represented by the word ‘Test’) is distorted in an inverse perspective manner. The image recorded by the camera is portrayed on a monitor as upright.

The claimed invention is not limited by the preferred embodiment shown. As a result, the design of the casing could also include more than the two components depicted here, and the shapes of the individual components can differ considerably from the illustrated shapes of the base segment and the upper segment. The casing can also be formed in one piece. For example, it can consist of shrink foil or shrink tubing, which is wrapped around the interior components of the mat and attaching tightly to the interior components of the mat by means of a heating process. The matrix of pixels can also be configured differently from the illustration; vertically adjacent pixel rows can form a staggered arrangement so that pixels located immediately above one another are staggered relative to one another at an angle of 45°. It is also possible that the LEDs are not arranged on conventional circuit boards, but rather inserted individually in recesses in the casing provided for this purpose and connected to the electronic control unit via a conductor. Individual LEDs can, for example, also be inserted in individual, step-resistant shells that are at least partially transparent, instead of being covered by cover panels. This allows the mat to become even more flexible.

1. A mat including:
a display surface configured to display a piece of information such that, from the viewing point of a camera, the viewing angle of which extends at an angle that is oblique to the display surface, the information appears to stand three-dimensionally upright, LEDs which are spread across the display surface and built into the mat and configured to enable information to be displayed, and an electronic control unit configured to control the LEDs individually, in groups according to any pattern.

2. The mat according to claim 1, further including a casing comprising at least one upper segment that forms the display surface and at least one base segment, wherein cavities for accommodating LEDs or circuit boards supporting LEDs are embedded in the upper segment, and/or in the base segment, or in both.

3. The mat according to claim 1, wherein current-carrying components of the mat have a waterproof covering.

4. The mat according to claim 1, wherein the mat is step-resistant.

5. The mat according to claim 1, wherein the display surface is comprised of a surface that is primarily non-transparent, in which a matrix of transparent or translucent segments is embedded, wherein an LED or a group of LEDs is assigned to a transparent or translucent segment.

6. The mat according to claim 2, wherein at least the upper segment of the casing is composed substantially of rubber or a rubber-elastic material.

7. The mat according to claim 1, wherein the LEDs are arranged on circuit boards, and wherein adjacent circuit boards are connected to one another by a connection that is articulated, flexible, or both.

8. The mat according to claim 7, wherein the circuit boards are covered with step-resistant cover panels.

9. The mat according to claim 8, wherein the step-resistant cover panels include transparent or translucent projections that are embedded as transparent or translucent segments of the display surface in recesses in an upper cover panel.

10. The mat according to claim 8, wherein the step-resistant covers overlap impact edges of adjacent LED circuit boards.

11. The mat according claim 1, wherein the mat is made of flame-resistant material.

12. The mat according to claim 1, further including means for decoding encoded image data, wherein the means for decoding are provided in the control unit, are arranged downstream from the control unit and upstream from the LEDs, or both.

13. The mat according to claim 1, further including connection means on at least one of its flat side of the mat, for connecting an additional mat module with a display surface fitted with LEDs, for connecting an additional electronic control unit, or for connecting both.

14. A method of transmitting information by at least one mat according to claim 1, the mat being located on a floor, the method including:
displaying the information on the at least one mat according to claim 1 such that it is enabled to be perceived by at least one camera, the position of which is able to be altered, wherein the displaying includes distorting the display of information according to a position of the at least one camera, such that the information is enabled to be perceived as substantially three-dimensionally upright when viewed from the position of the at least one camera.

15. The method according to claim 14, wherein the distorting comprises distorting the information by the control unit.

16. The method according to claim 14, further including selecting the information to be displayed by the mat according to the position of the at least one camera from a plurality of pieces of information available for display.

17. The method according to claim 14, wherein the distorting comprises tilting a representation of the information at an angle.

18. The method according to claim 14, wherein the distorting is determined in real time according to the position of the at least one camera, based at least in part on a change in location of a camera or on a switching of a camera to which the information is intended to be transmitted as substantially three-dimensionally upright to a different camera.

19. The method according to claim 14, wherein two or more pieces of information are displayed on the display surface simultaneously, wherein the display of at least a first one of the pieces of information is distorted according to the position of the at least one camera to which the first one of the pieces information is intended to be transmitted as substantially three-dimensionally upright, and wherein the display of at least a second one of the pieces of information is distorted according to the position of another camera to which the second one of the pieces of information is intended to be transmitted as substantially three-dimensionally upright.

20. The method according to claim 14, further including simultaneously displaying two or more pieces of information, wherein the two or more pieces of information are distorted in such a way that, when viewed from the position of the at least one camera, the two or more pieces of information appear to be standing three-dimensionally upright, one behind the other.

21. A system for transmitting image data, the system including at least one camera, a position of which is able to be altered during transmission, and at least one mat according to claim 1.

22. The system according to claim 21, further including means using which a signal is sent to the electronic control unit that enables the electronic control unit to learn which camera is active as regards transmitting the information, where the camera which is active as regards transmitting information is located, or both.

23. The system according to claim 21, wherein coloured display of the information is able to be calibrated automatically by means of a visual comparison with the at least one camera according to adjustable colour values or manually using software.

24. The system according to claim 21, wherein a display refresh rate of the mat is calibrated with the at least one camera.
